(19) United States
(12) Patent Application Publication
(10) Pub. No.: US 2026/0138170 A1
(43) Pub. Date: May 21, 2026

(54) Shear Assisted Extrusion Apparatus, Tools, and Methods

(71) Applicant: Battelle Memorial Institute, Richland, WA (US)

(72) Inventors: Brandon Scott Taysom, West Richland, WA (US); MD. Reza-E-Rabby, West Richland, WA (US); Scott A. Whalen, West Richland, WA (US)

(21) Appl. No.: 19/397,396

(22) Filed: Nov. 21, 2025

Related U.S. Application Data
(63) Continuation of application No. 17/857,951, filed on Jul. 5, 2022, now Pat. No. 12,502,701.

(51) Int. Cl. B21C 25/02; B21C 23/00; B21C 23/08; B21C 29/00; B29C 48/30

(52) U.S. Cl. CPC B21C 25/02; B21C 23/001; B21C 23/085; B21C 29/003; B29C 48/301

(57) ABSTRACT

Shear assisted extrusion apparatus, tools, inserts, and/or methods are provided. The apparatuses can include: an extrusion receiving channel operably engaged with a tool to receive extruded material; and one or more openings aligned between the spindle ends, the openings configured to convey fluid to the extruded product. Example tools can include one or more openings aligned between the tool ends. Example methods can include quenching plasticized feed material before exiting the spindle. A spindle assembly and/or tool assembly inserts are also provided that can include a sleeve extending within one or both of the spindle assembly or tool assembly of the apparatus; and openings within the sleeve configured to convey fluid to within one or both of the receiving channel of the spindle assembly or the tool assembly.

### CROSS REFERENCE TO RELATED APPLICATIONS

This application is a continuation of U.S. patent application Ser. No. 17/857,951, filed Jul. 5, 2022, the entirety of which is hereby incorporated by reference herein.

This application is also related to U.S. Continuation-In-Part patent application Ser. No. 17/473,178 filed Sep. 13, 2021, entitled “Devices and Methods for Performing Shear-Assisted Extrusion and Extrusion Processes”, the entirety of which is hereby incorporated by reference herein.

### STATEMENT AS TO RIGHTS TO INVENTIONS MADE UNDER FEDERALLY-SPONSORED RESEARCH AND DEVELOPMENT

This invention was made with Government support under Contract DE-AC05-76RL01830 awarded by the U.S. Department of Energy. The Government has certain rights in the invention.

### TECHNICAL FIELD

The present disclosure relates to metals technology in general, but more specifically to extrusion technology.

### BACKGROUND

Increased needs for fuel efficiency in transportation coupled with ever increasing needs for safety and regulatory compliance have focused attention on the development and utilization of new materials and processes. In many instances, impediments to entry into these areas has been caused by the lack of effective and efficient manufacturing methods. For example, the ability to replace steel car parts with materials made from magnesium or aluminum or their associated alloys is of great interest. Additionally, the ability to form hollow parts with equal or greater strength than solid parts is an additional desired end. Previous attempts have failed or are subject to limitations based upon a variety of factors, including the lack of suitable manufacturing process, the expense of using rare earths in alloys to impart desired characteristics, and the high energy costs for production.

What is needed is a process and device that enables the production of items such as components in automobile or aerospace vehicles with hollow cross sections that are made from materials such as magnesium or aluminum with or without the inclusion of rare earth metals. What is also needed is a process and system for production of such items that is more energy efficient, capable of simpler implementation, and produces a material having desired grain sizes, structure and alignment so as to preserve strength and provide sufficient corrosion resistance. What is also needed is a simplified process that enables the formation of such structures directly from billets, powders or flakes of material without the need for additional processing steps. What is also needed is a process and associated equipment that reduces or eliminates the need for energy intensive thermal heat treatment steps before and/or after extrusion. What is also needed is a new method for forming high entropy alloy materials that is simpler and more effective than current processes. The present disclosure provides a description of significant advance in meeting these needs.

Over the past several years researchers at the Pacific Northwest National Laboratory have developed a novel Shear Assisted Processing and Extrusion (ShAPE) technique which uses a rotating tool as a ram or die receiving axially fed billet rather than an axially fed billet without rotations as is used in the conventional extrusion process. As described hereafter as well as in the previously cited, referenced, and incorporated patent applications, this process and its associated devices provide a number of significant advantages including reduced power consumption, fewer and less demanding heat treatments, better material properties, and new sets of “solid phase” types of forming process and machinery. Deployment of the advantages of these processes and devices are envisioned in a variety of industries and applications including but not limited to transportation, projectiles, high temperature applications, structural applications, nuclear applications, and corrosion resistance applications.

The present disclosure overcomes many requirements of the prior art by removing steps entirely and providing extruded materials that are higher in quality than those prepared from these prior art methods.

### SUMMARY

Shear assisted extrusion apparatuses are provided. The apparatuses can include: a spindle assembly extending from a first end to a second end, the spindle assembly configured to rotate about a distance between the first and second end; a tool operably engaged with the spindle and defining the second end of the spindle assembly, the tool configured to engage feed material with shear force provided from the spindle; an extrusion receiving channel operably engaged with the tool to receive extruded material; and one or more openings aligned between the first and second end, the openings configured to convey fluid to the extruded product.

Shear assisted extrusion tools are also provided. The tools can include: a conduit extending from a first end to a second end, the first end defining a die face and configured to engage feed material, the second end configured to operably couple to a spindle of a shear assisted extrusion apparatus; and one or more openings aligned between the first and second end, the openings configured to convey fluid through interior walls of the conduit and/or die face.

Methods for quenching a product of shear assisted extrusion are also provided. The methods can include: providing shear assisted force to a die face operably engaged with a spindle of a shear assisted extrusion apparatus; and receiving plasticized raw material from the die face and quenching the plasticized feed material before exiting the spindle.

A spindle assembly and/or tool assembly insert is provided, including: a sleeve extending within one or both of the spindle assembly or tool assembly of the apparatus; and openings within the sleeve configured to convey fluid to within one or both of the receiving channel of the spindle assembly or the tool assembly.

The apparatuses, tools, inserts, and/or methods of the present disclosure are example configurations and are not exhaustive of all configurations contemplated.

### DESCRIPTION OF THE DRAWINGS

Embodiments of the disclosure are described below with reference to the following accompanying drawings.

FIG. 1 is a portion of a shear assisted extrusion apparatus according to an embodiment of the disclosure.

FIG. 2 is another configuration of a portion of a shear assisted extrusion apparatus according to an embodiment of the disclosure.

FIG. 3 is a more detailed view of a portion of a shear assisted extrusion apparatus according to an embodiment of the disclosure.

FIG. 4 is a depiction of a portion of a shear assisted extrusion apparatus according to an embodiment of the disclosure.

FIG. 5 is a shear assisted extrusion apparatus according to an embodiment of the disclosure.

FIG. 6 is a more detailed view of a portion of a shear assisted extrusion apparatus according to an embodiment of the disclosure.

FIG. 7 is an exterior view of components of a shear assisted extrusion apparatus according to an embodiment of the disclosure.

FIG. 8 is a detailed view of a portion of a shear assisted extrusion apparatus according to an embodiment of the disclosure.

FIG. 9 is a detailed view of a shear assisted extrusion apparatus according to an embodiment of the disclosure.

FIG. 10 is view of components of a shear assisted extrusion apparatus having a quenching insert therein according to an embodiment of the disclosure.

FIG. 11 is a detailed view of a portion of engagement of a quenching insert with a component of a shear assisted extrusion apparatus according to an embodiment of the disclosure.

FIG. 12 is a detailed view of a portion of engagement of a quenching insert with components of a shear assisted extrusion apparatus according to an embodiment of the disclosure.

FIG. 13 is a detailed view of the components of FIG. 12 according to an embodiment of the disclosure.

FIG. 14 is a detailed view of the components of FIG. 13 according to an embodiment of the disclosure.

FIG. 15 is a detailed view of the components of FIG. 14 according to an embodiment of the disclosure.

FIGS. 16 and 17 are both depictions of different quench head configurations according to an embodiment of the disclosure.

FIG. 18 is a depiction of a quench assembly within a shear assisted extrusion apparatus according to an embodiment of the disclosure.

FIGS. 19 and 20 are depictions of discharge assemblies according to embodiments of the disclosure.

### DESCRIPTION

This disclosure is submitted in furtherance of the constitutional purposes of the U.S. Patent Laws “to promote the progress of science and useful arts” (Article 1, Section 8).

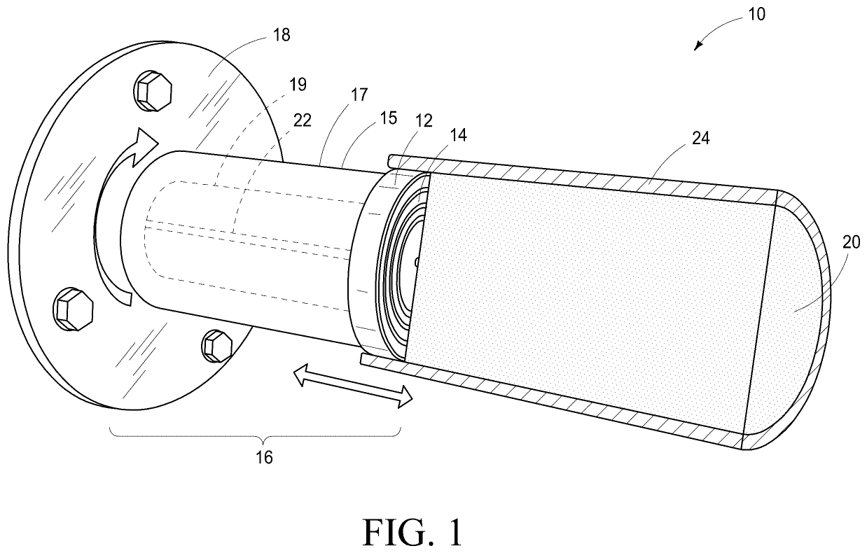

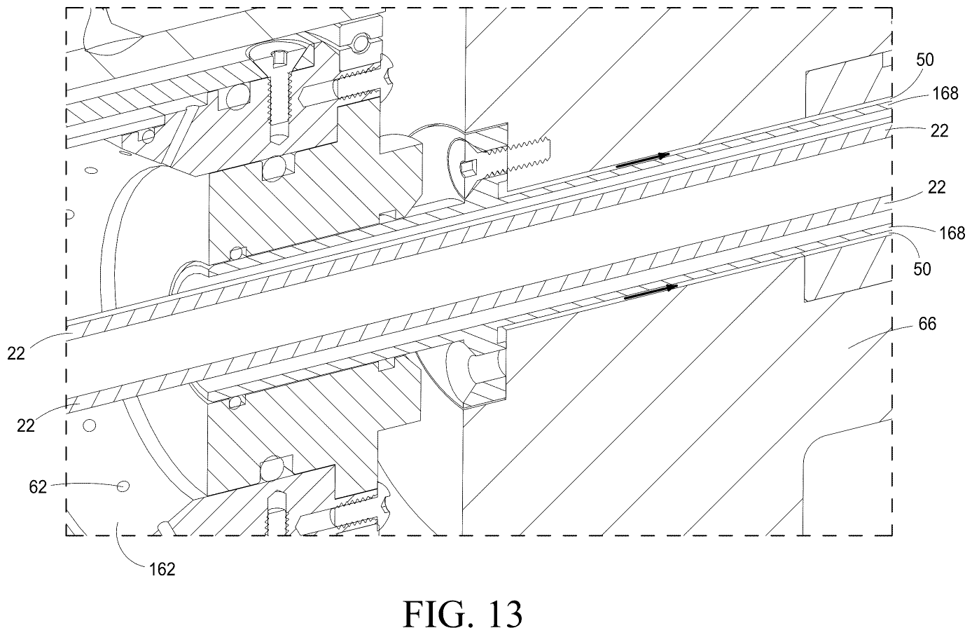

The apparatuses, tools, and methods of the present disclosure will be described with reference to FIGS. 1-20. Referring first to FIG. 1, a portion of a shear assisted extrusion apparatus 10 is shown that includes feed material 20 within a feed material container 24 as well as a shear assisted extrusion tool 16 that includes a tool head 12 as well as a die face 14 extending to shank 15. Shank 15 can be defined by a tube having interior 19 and exterior sidewalls 17. Tool 16 also includes a flange 18 that can be operably coupled to a spindle assembly not yet shown. In this configuration, tool 16 is a single piece. Other configurations of tool 16 can be assemblies of multiple components. Example tool assemblies are depicted herein. As shown, a rotational force and axial force is applied to tool head 12. The axial force may be applied from the tool upon the feed material; alternatively, the axial force may be applied from the feed material upon the tool. In accordance with example implementations, the shear assisted extrusion process will provide an extrusion material 22.

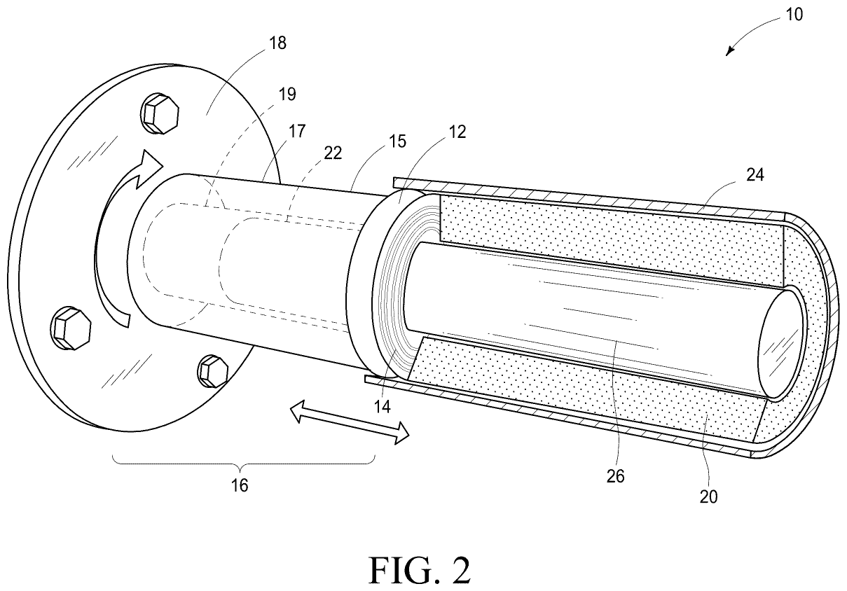

Referring next to FIG. 2, a portion 10 of an apparatus is shown that includes the use of a mandrel 26 that provides for feed material 20 to be provided to die face 14 and/or to within tool 16. Mandrel 26 can extend to die face 14 where feed material is plasticized and plasticized material continues as extrusion material within tool 16 to form extrusion material 22. Alternatively, mandrel 26 can continue beyond die face 14 and provide support for extrusion material within tool 16 after formation at die face 14. In accordance with example implementations, material 22 can take the shape of mandrel 26. Extrusion materials, including non-circular multi-cell profiles, can also be formed using a port hole bridge tool/die configuration as an alternative to the depicted mandrel approach.

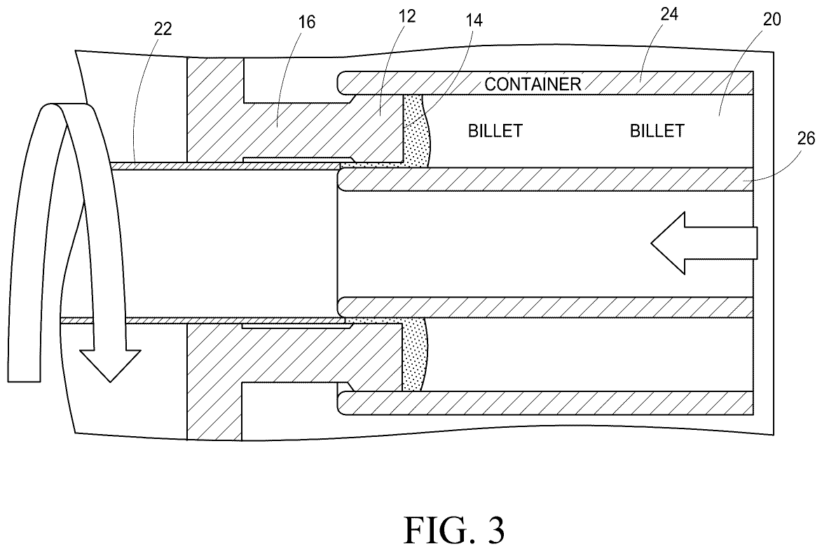

Referring next to FIG. 3, a cross sectional view of FIG. 2 is provided that includes mandrel 26 that supports feed materials also known as billets 20 within container 24. As shown, tool 16 can include a die face 14 as well as a tool head 12, and this provides for an extrusion material 22 formed upon a rotational and axial force as shown.

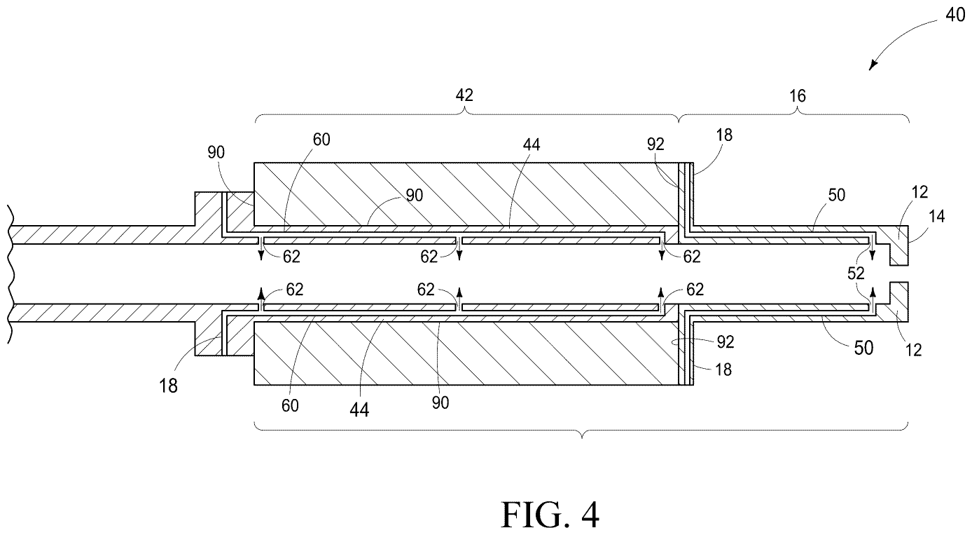

Referring next to FIG. 4, in accordance with example implementations, apparatus portion 40 is shown that includes both a tool 16 as well as a spindle 42 that rotates about a receiving channel 44. Importantly, receiving channel 44 is stationary or fixed in relation to spindle 42. Spindle 42 operably rotates tool 16 in order to provide the rotational force referred to herein, and this spindle extends from one end 92, where it couples with tool 16 at, for example, flange 18, and another end 90 where it couples with the remainder of the apparatus and rotation ends, allowing receiving channel 44 to continue as shown. Accordingly, interfaces 90 and 92 are shown that allow for spindle 42 to rotate while channel 44 remains fixed. Alternatively, at interface 92 between flange 18 and spindle 42, the components are fixed, thereby providing for rotation of tool 16 in accordance with rotation of spindle 42.

In accordance with example implementations and with reference to FIG. 4, passageways 60 are provided within receiving channel 44 and passageways 50 are provided to tool 16. As shown, openings 52 can enter the interior walls of tool 16 and openings 62 can enter the interior walls of the receiving channel from these passageways. To these passageways can be provided a fluid, such as a coolant. Examples of the coolant can include but are not limited to water, air, inert gas, liquid nitrogen, nitrogen mist, and/or quench oil.

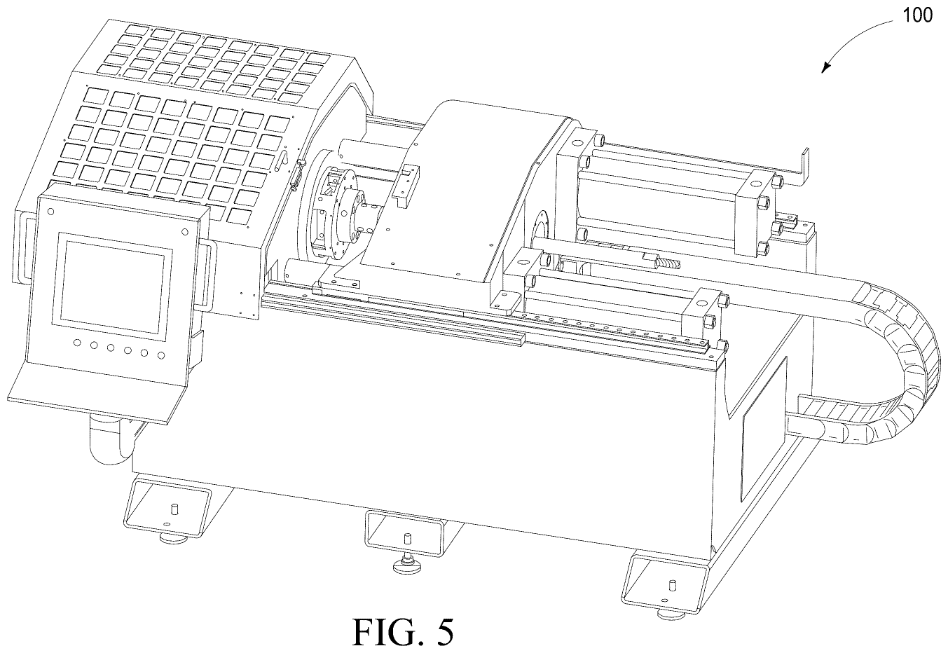

Referring next to FIG. 5, the portions of the apparatus provided herein can be operably engaged using a complete apparatus as shown. This example apparatus is known as a “Friction Extrusion Machine” or “Shear Assisted Processing and Extrusion Machine”, examples and operation of which are further provided in U.S. patent application Ser. No. 17/473,178 filed Sep. 13, 2021, which was published Dec. 30, 2021, as Publication No. US 2021/0402471 A1, the entirety of which is incorporated herein by reference.

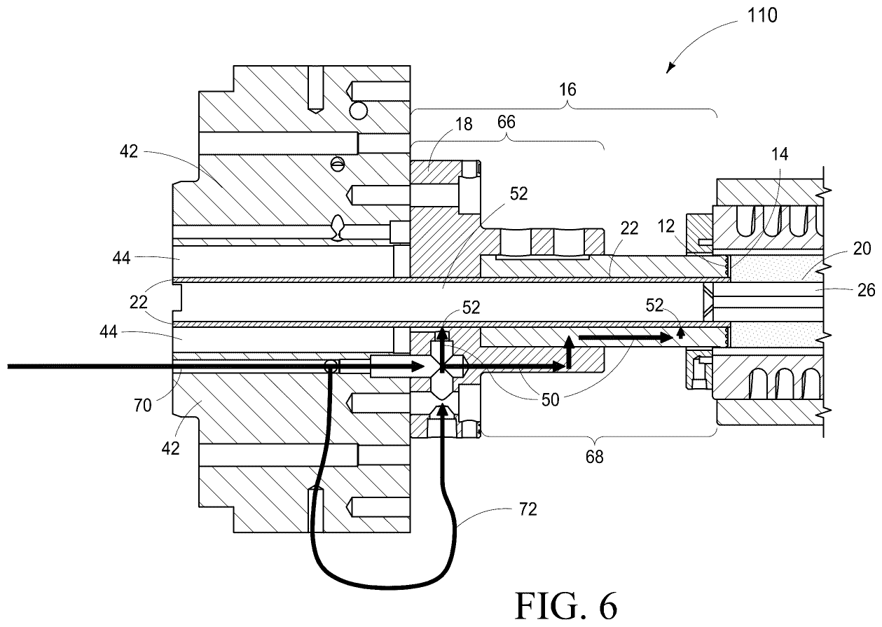

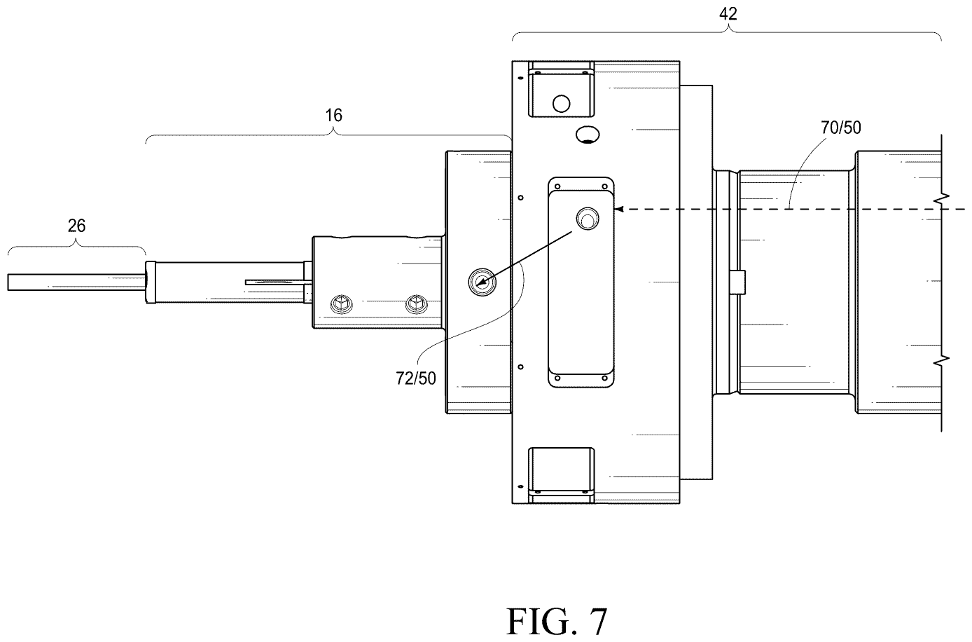

Referring next to FIG. 6, in accordance with one particular embodiment, apparatus portion 110 can include mandrel 26 that supports feed material 20. This feed material 20 can engage die face 14 at tool head 12 and be plasticized to form extrusion material 22. In accordance with example implementations, fluid can be provided through spindle 42 that can include a spindle faceplate at passageway 70 or 72 via outside the spindle and/or via flange 18 of tool assembly 16. As depicted herein, tool assembly 16 can include tool or die holder 66 and die 68. In accordance with example implementations, passageway 50 can continue and fluid can be provided through openings 52 to within interior walls of tool 16. FIG. 7 depicts an exterior view of spindle 42 coupled with tool assembly 16 and mandrel 26. As shown, passageways 70/50 and/or 72/50 provide fluid to tool assembly 16.

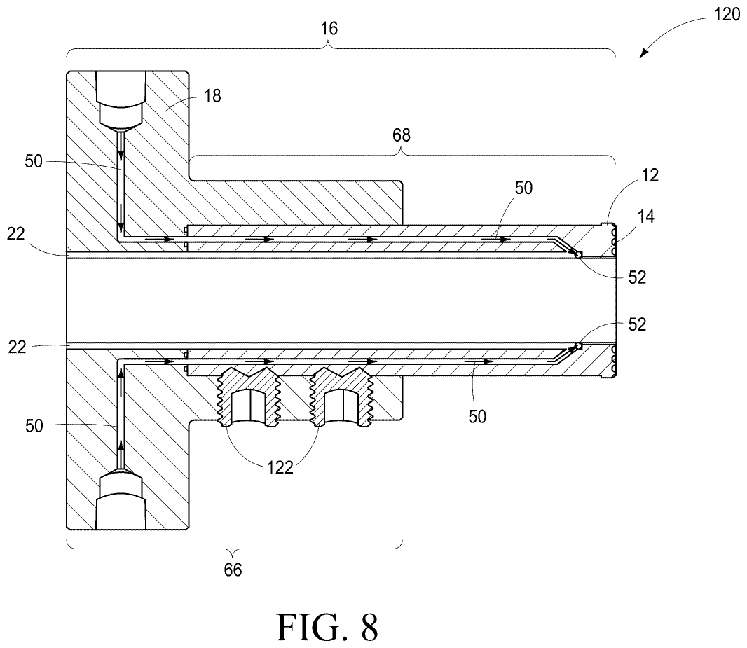

Referring next to FIG. 8, another example implementation of an apparatus portion 120 of a shear assisted extrusion apparatus is shown that includes tool assembly 16 having tool holder 66 operatively coupled with tool/die 68. Tool/die 68 includes die face 14 and tool head 12. In accordance with example implementations, passageways 50 can extend through holder 66 and through walls of tool/die 68 and then be in fluid communication with openings 52 which enter into the rear face or supporting face of die face 14. At head 12 plasticized material is formed and flows to be cooled or quenched. As depicted, assembly 16 can include couplers 122 that can be used to couple tool/die 68 to holder 66.

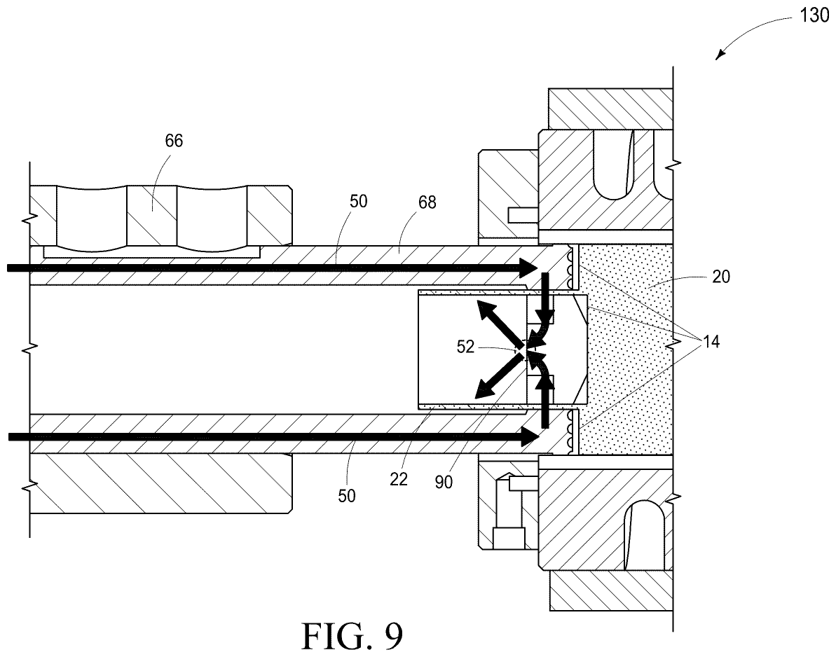

Referring next to FIG. 9, in accordance with yet another implementation, apparatus portion 130 of a shear assisted extrusion apparatus is shown that includes feed material 20 engaging with die face 14 at tool head 12. In accordance with example implementations, conduit 50 can extend through tool 68 and exit at openings 52 which are located on the support or rear face 90 of die face 14.

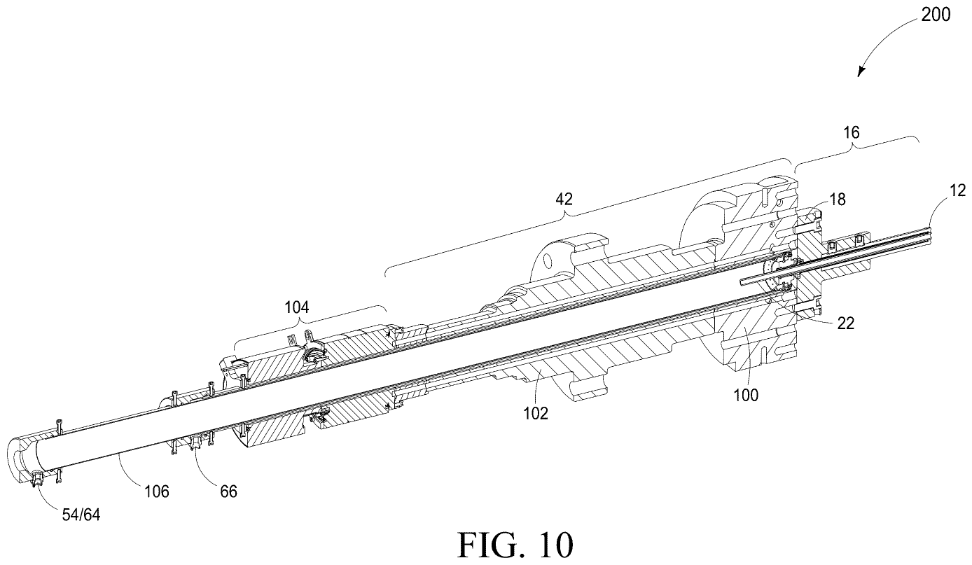

Referring next to FIG. 10, as shown, assembly 200 is shown that includes tool assembly 16 operatively coupled to spindle assembly 42 that includes spindle face plate 100 coupled to spindle 102. Spindle 102 is operatively engaged with rotary union 104. Within assembly 200 is quench assembly 106. Quench assembly 106 can be part of these components and/or an insert to already assembled components. Spindle assembly 42 can encompass components that rotate axially about a distance between ends of the spindle assembly, for example about a distance between tool assembly 16 and rotary union 104, face plate 100 and rotary union 104, and/or the length of spindle 102.

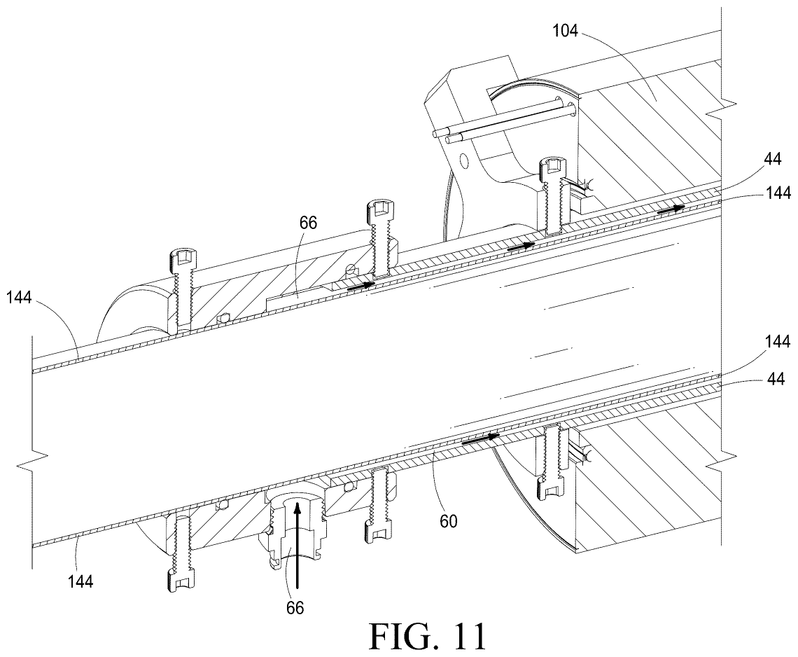

Referring next to FIG. 11, in accordance with example implementations, fluid can be provided via intake 66 to within passageway 60 formed between receiving channel 44 and sleeve 144 to openings 62 within sleeve 144. As shown, sleeve 144 extends into rotary union 104 and continues through spindle 42.

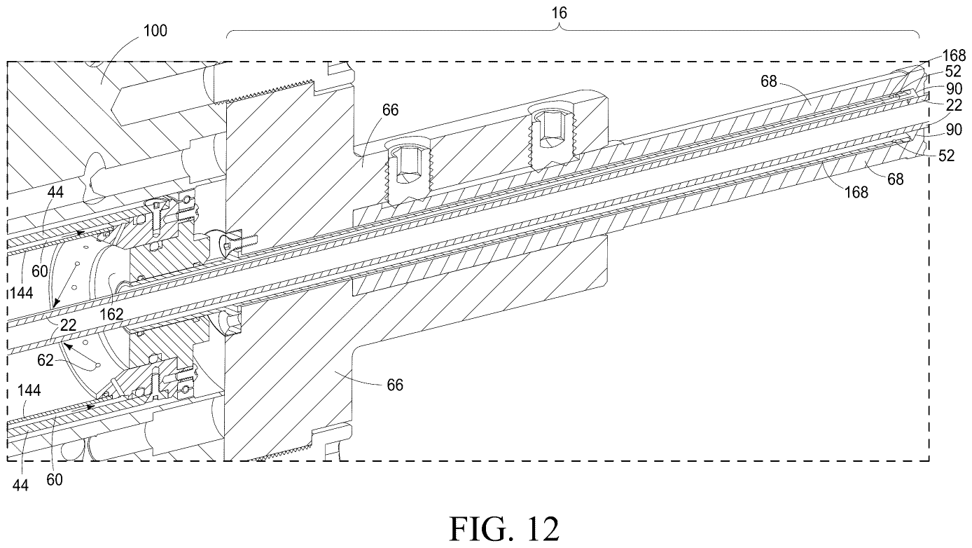

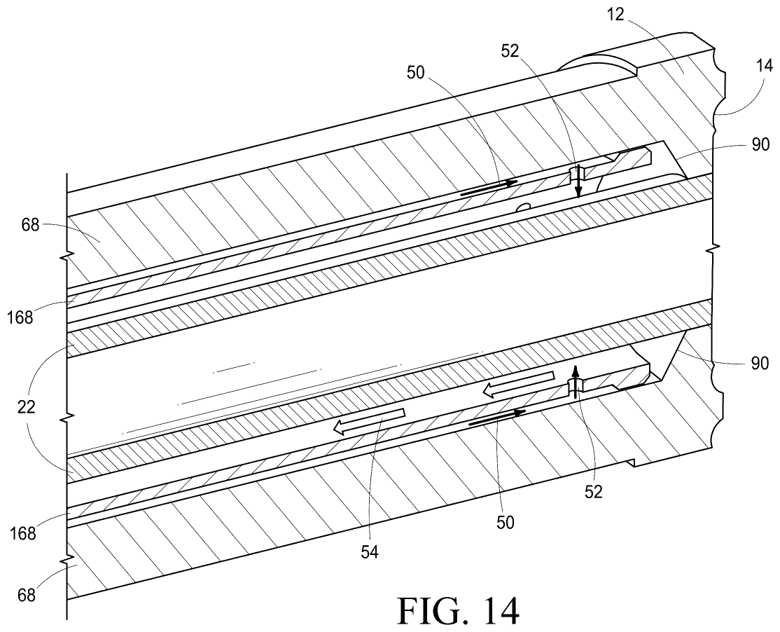

Referring next to FIGS. 12-14 and with reference to previous FIG. 10, a quench assembly 106 is depicted that can extend into spindle 42 through to tool assembly 16. In particular embodiments, assembly 106 can include a quench head 162. Quench head 162 can include a plurality of openings 62 that are in fluid communication with passageways 60 provided between sleeve 144 and receiving channel 44. In accordance with example implementations, quench head 162 can be aligned within spindle faceplate 100 proximate tool assembly 16, which can be configured to receive extrusion material 22. Sleeve 168 can be operatively engaged with tool assembly 16 and extend from tool holder 66 or quench head 162 to support 90 to form passageways 50 between assembly 16 and extrusion material 22. Accordingly, fluid may be provided to passageways 60 to passageways 50 and exit within tool assembly 16 at openings 52. As shown in FIG. 14, spent or used fluid 54 is shown returning along extrusion material 22.

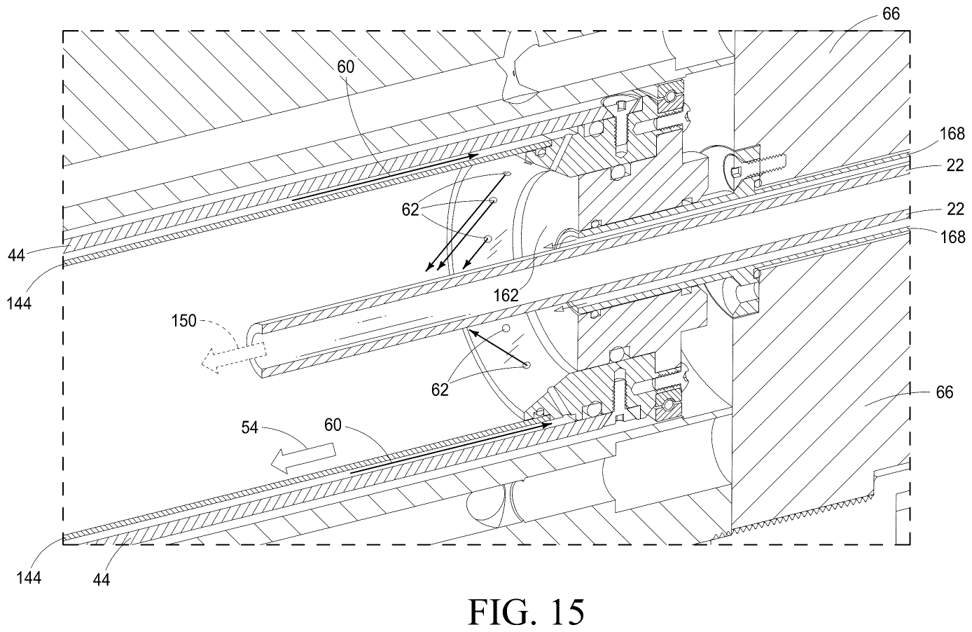

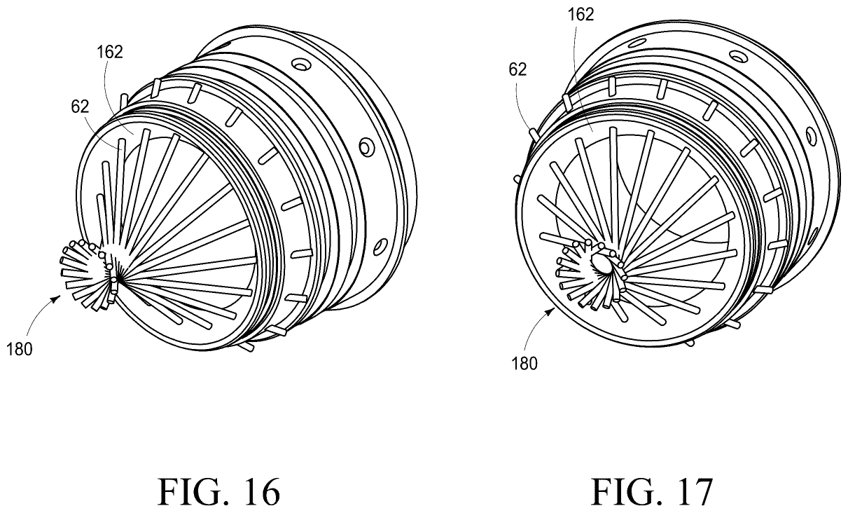

As shown in FIG. 15, fluid 54 continues along with extrusion material 22 in the direction of extrusion 150. Accordingly, fluid 54 flow can be further facilitated by fluid from openings 62. As shown in FIGS. 16 and 17, openings 62 can be configured to direct fluid flow about extrusion material without directing the fluid flow at one another. Accordingly, the fluid flow can be offset to form a radial engagement 180 of various sizes. As shown, the radius of radial engagement in FIG. 16 is smaller than the radius of radial engagement shown in FIG. 17.

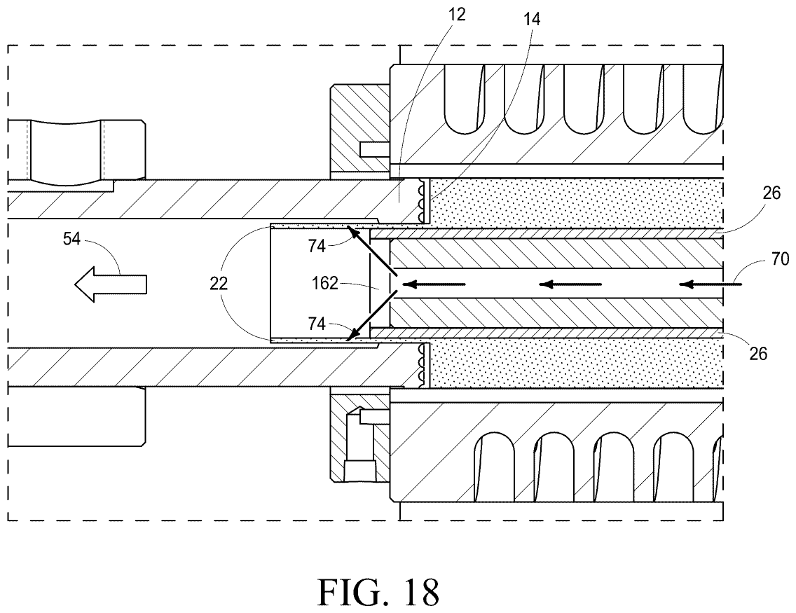

In accordance with yet another example, as shown in FIG. 18, fluid can be provided via mandrel 26 to a quench head 162 having openings 74 to quench an interior of extrusion material 22. Spent or used fluid 54 can continue in the direction of extrusion.

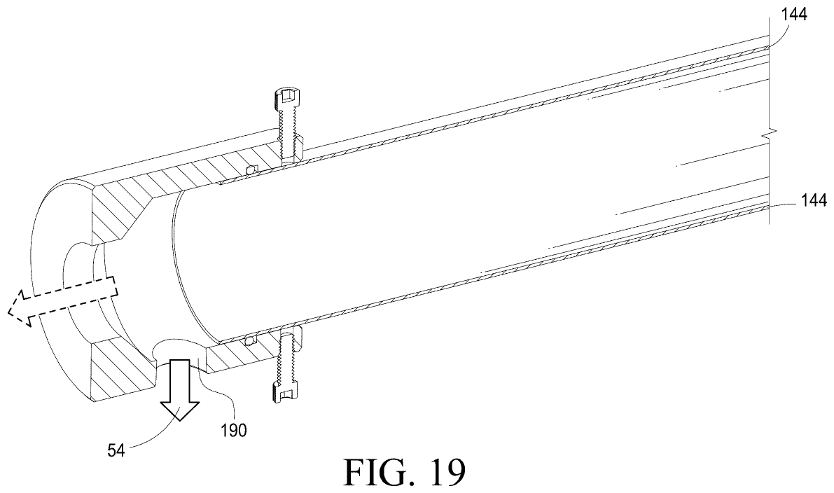

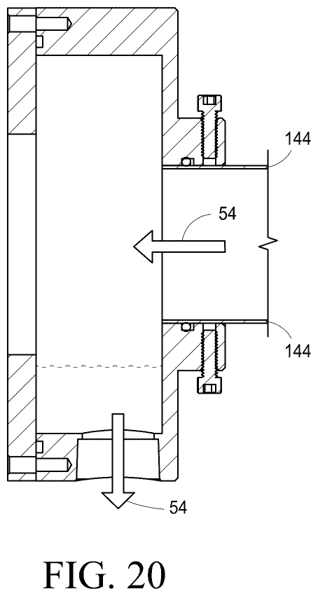

Referring next to FIGS. 19 and 20, fluid 54 can be retrieved for reuse at opening 190. Opening 190 can be part of a reservoir assembly, as shown in FIG. 20, to avoid fluid 54 continuing with extrusion material. This discharge can be recycled and then re-cooled and returned for future use.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect. The invention is, therefore, claimed in any of its forms or modifications within the proper scope of the appended claims appropriately interpreted in accordance with the doctrine of equivalents.

1. (canceled)

2. A quench apparatus for a shear assisted extrusion system, the quench apparatus comprising:
a sleeve sized and shaped for placement within a channel of a shear assisted extrusion system, the channel to receive feedstock material extruded through a face of a shear assisted extrusion tool, the sleeve establishing a fluid passageway between an interior-facing portion of the shear assisted extrusion system defining the channel and an outward-facing portion of the sleeve; and
a quench head operatively coupled with the sleeve and configured to direct fluid from the fluid passageway toward the extruded feedstock material within the channel.

3. The quench apparatus of claim 2, wherein the channel of the shear assisted extrusion system extends through a spindle configured to rotate the shear assisted extrusion tool relative to the feedstock material.

4. The quench apparatus of claim 3, wherein a spindle defining the channel and the shear assisted extrusion tool are configured to rotate about the sleeve.

5. The quench apparatus of claim 2, wherein the fluid passageway fluidically couples a fluid inlet outside the channel to the quench head.

6. The quench apparatus of claim 2, wherein the sleeve comprises a fluid outlet to permit recovery of fluid from within the sleeve after the fluid exits the quench head.

7. The quench apparatus of claim 6, wherein the fluid outlet is at an axial location along the sleeve that extends beyond the channel of the shear assisted extrusion system.

8. The quench apparatus of claim 2, wherein the quench head defines openings around a circumference of the quench head to direct streams of fluid radially inward toward the extruded feedstock material.

9. The quench apparatus of claim 8, wherein the openings are configured to direct the streams in a manner where the streams do not intersect with each other.

10. The quench apparatus of claim 2, wherein the channel of the shear assisted extrusion system extends through the shear assisted extrusion tool.

11. The quench apparatus of claim 10, wherein the sleeve defines one or more openings to direct fluid from the fluid passageway to extruded feedstock material within the shear assisted extrusion tool, separate from the quench head.

12. The quench apparatus of claim 2, wherein the sleeve comprises a portion extending radially outward to contact the interior-facing portion of the shear assisted extrusion system to close off the fluid passageway.

13. A shear assisted extrusion system, comprising:
a spindle configured to establish rotation of a shear assisted extrusion tool relative to a feedstock material; and
a quench apparatus comprising:
a sleeve sized and shaped for placement within a channel of a shear assisted extrusion system, the channel to receive feedstock material extruded through a face of the shear assisted extrusion tool, the sleeve establishing a fluid passageway between an interior-facing portion of the shear assisted extrusion system defining the channel and an outward-facing portion of the sleeve; and
a quench head operatively coupled with the sleeve and configured to direct fluid from the fluid passageway toward the extruded feedstock material within the channel.

14. The shear assisted extrusion system of claim 13, wherein the quench apparatus is a removable assembly.

15. The shear assisted extrusion system of claim 13, wherein the channel of the shear assisted extrusion system extends through the spindle.

16. The shear assisted extrusion system of claim 15, wherein a spindle defining the channel and the shear assisted extrusion tool are configured to rotate about the sleeve.

17. A method for performing shear assisted extrusion, comprising:
establishing rotation of a shear assisted extrusion tool relative to a feedstock material;
axially engaging the feedstock material with the shear assisted extrusion tool to extrude the feedstock material through a face of the shear assisted extrusion tool; and
quenching the extruded feedstock material using a quench apparatus, the quench apparatus comprising:
a sleeve sized and shaped for placement within a channel of a shear assisted extrusion system, the channel to receive feedstock material extruded through the face of the shear assisted extrusion tool, the sleeve establishing a fluid passageway between an interior-facing portion of the shear assisted extrusion system defining the channel and an outward-facing portion of the sleeve; and
a quench head operatively coupled with the sleeve and configured to direct fluid from the fluid passageway toward the extruded feedstock material within the channel.

18. The method of claim 17, wherein the channel of the shear assisted extrusion system extends through a spindle; and
wherein the method comprising rotating the shear assisted extrusion tool relative to the feedstock material using the spindle.

19. The method of claim 18, wherein the spindle and shear assisted extrusion tool rotate about the sleeve.

20. The method of claim 17, wherein the quench head defines openings around a circumference of the quench head; and
wherein the method comprises directing streams of fluid radially inward toward the extruded feedstock material using the openings of the quench head.

21. The method of claim 20, wherein the streams do not intersect with each other.
